(19) United States
(12) Patent Application Publication
(10) Pub. No.: US 2012/0265705 A1
(43) Pub. Date: Oct. 18, 2012

(54) BENEFITS SELF SERVICE PRODUCT

(75) Inventors: Lynda Tollefson, Orlando, FL (US); Ashton Kawanishi, Mountain View, CA (US); David O'Meara, Reading (GB)

(73) Assignee: Oracle International Corporation, Redwood Shores, CA (US)

(21) Appl. No.: 13/085,687

(22) Filed: Apr. 13, 2011

(51) Int. Cl. G06Q 10/00

(52) U.S. Cl. 705/322

(57) ABSTRACT

A system and method for selectively conveying information via a benefits self service product. An example method includes determining, with reference to a repository of employee data, characteristics associated with an employee or prospective employee; ascertaining employee benefits options offered by an enterprise; employing the characteristics and the benefits options to select one or more example matches between one or more benefits options and an employee or prospective employee; and displaying an indication of the one or more example matches to an employee of the enterprise. In a more specific embodiment, a user interface enables an administrator to specify information comprising different cards in a set of predetermined cards. The indication of one or more example matches is provided via an electronic card that is selected from among the set of cards. The selected card is adapted to convey information pertaining to an example set of previously made choices by others with characteristics that match the characteristics of the employee or prospective employee.

### BACKGROUND

The present application relates to software and more specifically to systems and methods for selectively displaying or otherwise conveying information to a user.

Systems and methods for selectively conveying information are ubiquitously employed in various demanding applications, including targeted web advertising, email marketing, corporate bulletins, and so on. Such applications often demand mechanisms for determining what information to convey to a user and when.

Information targeting methods are particularly important in various enterprise applications, where informed decision making often depends upon timely delivery of relevant information. For example, a newly hired employee may wish to choose a benefits package from a combination of different plans and options. However, information regarding benefits options can be overwhelming. The employee may need assistance making complex benefits choices based on various criteria. These criteria can be related to personal health, family status, location, work attributes, age, gender, and so on.

Conventionally, voluminous information about available benefits options for employees is provided in bulk. The information is typically analyzed by each employee to ensure appropriate benefits-related decisions are made. Significant time may be spent reviewing information, since benefits decisions can be particularly important. Existing information targeting methods may fall short in helping users make sense of such potentially voluminous data or to otherwise efficiently make informed decisions.

### SUMMARY

An example method for selectively conveying information includes determining, with reference to a repository of employee data, characteristics associated with an employee or prospective employee; ascertaining employee benefits options offered by an enterprise; employing the characteristics and the benefits options to select one or more example matches between one or more benefits options and an employee or prospective employee; and displaying an indication of the one or more example matches to an employee of the enterprise.

In a more specific embodiment, an administrator user interface enables an administrator to specify information comprising different user interface cards in a set of predetermined cards. The indication of one or more example matches is provided via a card that is selected from among the set of cards. The selected card is adapted to convey information pertaining to an example set of previously made choices by others with characteristics that match the characteristics of the employee or prospective employee.

In an illustrative embodiment, a user, such as an employee, is provided an electronic questionnaire. User responses to the questionnaire are stored in a repository of employee data. The questionnaire is adapted to retrieve information from the user, e.g., employee or prospective employee, pertaining to benefits-related criteria. The criteria indicate whether an employee or prospective employee is eligible for a particular benefits plan. Example criteria include the number of dependents, location, and age of the employee or prospective employee.

A mapping algorithm may be employed to automatically match data associated with the employee or prospective employee with example benefits choices. A widget, which is adapted to display the selected card, may be presented to the user, i.e., employee or prospective employee, via a user interface. The widget-implemented card may include video, text, links, and/or other mechanisms for providing the indication of the one or more example matches between a set of benefits options or choices and the employee or prospective employee.

The widget may include a user option to enable the employee or prospective employee to select from among one or more benefits options. The repository of employee data may include data indicating a history of previous decisions made by employees or prospective employees of the enterprise. Software, including the mapping algorithm, is employed to determine previous decisions made by one or more employees or prospective employees that exhibit characteristics or selection criteria matching characteristics of an employee or prospective employee that is to make a decision pertaining to one or more benefits options. Example benefits options include an option to select a particular health care provider and an option to select a particular retirement plan or components thereof.

An algorithm for generating predictive analytics may generate a prediction as to what benefits options the employee or prospective employee will chose based on previous choices made by one or more employees of the enterprise. The resulting prediction is provided to the user via one or more cards and accompanying widgets.

In the illustrative embodiment, the repository of employee data includes a repository of anonymous employee data and data pertaining to an employee or prospective employee of the enterprise. The repository of anonymous employee data may include industry-wide data, which includes data from one or more employees of another enterprise.

Hence, certain embodiments discussed herein provide efficient mechanisms for selectively conveying information to a user for facilitating benefits-related decision making The information, which may include examples of what choices others have made in similar situations, may help guide the user through an otherwise potentially overwhelming set of choices and options.

In general, employees often like to understand what other people similar to them are choosing related to health and welfare benefits options. However, privacy rules governing health and welfare information have heretofore limited a user's ability to directly access information about choices made by others. Certain embodiments discussed herein overcome this problem.

Employers will now have the flexibility to present related information, such as via mini-case studies, that represent the major demographic of the employee population with cards that exist in the contextual regions and which may include text, images and embedded video. The employer may configure these cards with their own text, video, or other content demonstrate an employee's outline and describe example health and welfare choices. In this way the employer can represent a match for the employee based on employee's own data, e.g., age, gender, job role, salary, dependents, length of service, and so on. Analytics processing can be configured so that a minimum number of matches need to be found to ensure that the sources cannot be identified.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram illustrating a first example embodiment of a system for facilitating conveying information to assist a user in making benefits-related decisions.

FIG. 2 is a flow diagram of a process adapted for use with the systems of FIG. 1.

FIG. 3 is a diagram of an example card to be displayed via a user interface display screen via a widget for presenting benefits-related information to a user.

FIG. 4 is a more detailed diagram illustrating a second example embodiment of a system for facilitating conveying benefits-related information to a user.

FIG. 5 is flow diagram of a first method adapted for use with the embodiments of FIGS. 1-4.

FIG. 6 is a flow diagram of a second method adapted for use with the embodiments of FIGS. 1-4.

FIG. 7 is a diagram illustrating an example user interface display screen showing multiple cards, which are presented to an employee or prospective employee.

### DETAILED DESCRIPTION OF EMBODIMENTS

Although the description has been described with respect to particular embodiments thereof, these particular embodiments are merely illustrative, and not restrictive.

For example, while the present application is discussed with respect to the use of Graphical User Interface (GUI) cards to convey information applicable to benefits choices to be made by an employee or prospective employee of an enterprise, embodiments are not limited thereto. For example, a user in any situation, where important decisions must be made in view of a complex set of information and criteria, may benefit from a system for selectively conveying example decisions made by others in similar situations. Furthermore, GUI cards may be replaced with other types of user interface display screens without departing from the scope of the present teachings.

For the purposes of the present discussion, an enterprise may be any organization of personnel and other resources. Examples of organizations include businesses, schools or universities, governments, non-profit organizations, and so on. Similarly, an enterprise application may be any software application designed for use by an enterprise, such as to facilitate running, managing, and/or documenting operations of the enterprise.

Benefits choices may be any decisions made or to be made regarding programs or benefits plans, such as health care, retirement, vacation, general welfare, and so on, that are adapted to benefit an employee or prospective employee. A benefits choice may refer to a choice that is to be made or that has been already made. Examples of benefits choices include a decision to signup with a first health care provider; a decision to accept a first retirement plan over a second retirement plan or option thereof, and so on.

For the purposes of the present discussion, a benefits plan may include one or more insurance policies, one or more retirement plans, one or more welfare plans, and so on. Benefits options may include any options associated with each benefits plan, such as the option to choose the plan itself or components thereof. In general, a benefits plan may be any plan associated with value to be received by the user. Specific details of plans, such as types of insurance and related options, are implementation specific and may be varied without departing from the scope of the present teachings.

Various embodiment discussed below may refer to an administrator, a user, an employee, and so on. In general, persons performing administrative roles, such as establishing the content of predetermined electronic cards, are called administrators. An administrator may be acting on behalf of an employer or enterprise using the system. However, the term “user,” as employed herein, generally refers to an employee or prospective employee that may be seeking information in preparation for selecting from among available benefits plans and accompanying options.

For clarity, certain well-known components, such as hard drives, processors, operating systems, power supplies, and so on, have been omitted from the figures. However, those skilled in the art with access to the present teachings will know which components to implement and how to implement them to meet the needs of a given application.

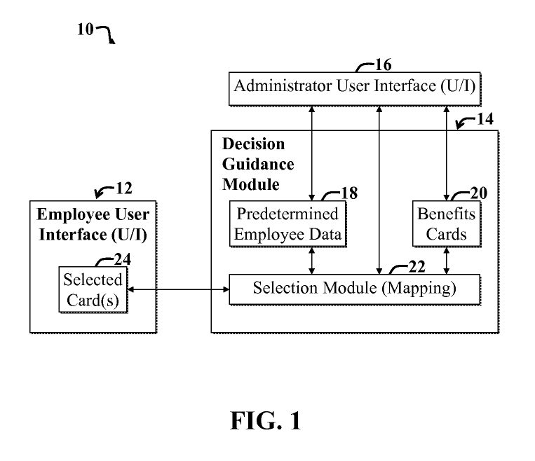

FIG. 1 is a diagram illustrating a first example embodiment of a system 10 for facilitating conveying information to assist a user in making benefits-related decisions. The system 10 includes an employee user interface 12 and an administrator user interface 16 in communication with a decision guidance module 14.

The decision guidance module 14 includes an employee data repository 18 and a set of predetermined benefits cards 20, which communicate with a mapping module 22. Each of the modules 18-22 of the decision guidance module 14 may communicate with the administrator user interface 16. The administrator user interface 16 may include software for enabling an administrator or other authorized personnel to modify or adjust data maintained by and/or functionality implemented by the various modules 18-22 of the decision guidance module 14, as discussed more fully below.

The employee user interface 12 may include software and hardware for enabling display of one or more cards 24. For the purposes of the present discussion, a card may be any electronically displayed collection of information. A card may be implemented via a window, dialog box, or other user interface mechanism(s). In the present specific example embodiment, the cards 24 are implemented via a Graphical User Interface (GUI) widget.

In general, the system 10 may be implemented on one or more computer systems and/or networks. Various modules 12-24 may be implemented via entirely custom computer code or may leverage existing software packages, such as various Enterprise Resource Planning (ERP) databases (such as Human Resources (HR) and Human Capital Management (HCM) databases), applications, and user interfaces commonly employee in an enterprise.

In operation, various types of employee information, also called employee data, are maintained via the employee data repository 18. The information includes data pertaining to predetermined characteristics of each employee. The predetermined characteristics are used as criteria to determine which available health care plans and options, retirement plans and options, and other benefits options may be available to a user. Example employee characteristics include, but are not limited to, whether an employee is married, has dependents, the employee's age, and the employee's residence or office location. Such information pertaining to employee characteristics may be predetermined, such as via an administrator, or may be collected via a specialized electronic questionnaire, as discussed more fully below.

In an example operative scenario, an administrator pre-configures various benefits cards 20 with reference to information pertaining to available benefits options and plans and with reference to particular employee characteristics or criteria that must be met to be eligible for each benefits option and/or plan. The information pertaining to available benefits options, plans, and eligibility criteria may be stored in the mapping module 22. The mapping module 22 may also store predetermined associations between different benefits cards 20 and different sets of employee data maintained by the employee data repository 18.

For example, an administrator may employ the administrator user interface 16 to associate, with one or more benefits cards 20, all employees that have employee data objects in the employee data repository 18, based on a mapping specified in the mapping module 22. For example, female employees over a certain age and residing in a particular region may be eligible for a health care plan A, a health care plan B, and a retirement plan C. However, if for example, historically, female employees meeting such criteria have chosen health care plan A over health care plan B, then health care plan A is preferentially associated with employees meeting such criteria. A corresponding benefits card 20 for employees matching the set of criteria is said to be mapped to the group of one or more employees meeting predetermined eligibility criteria, via a mapping function maintained via the mapping module 22.

The mapping implemented via the mapping module 22 may be directly specified by the administrator employing the user interface 16, or alternatively, the mapping is automatically determined based on preexisting information about available benefits options and plans and employee eligibility criteria. In addition, while in the present embodiment, the administrator user interface 16 includes one or more routines for enabling an administrator to configure content of various benefits cards 20 and to associate the various benefits cards with employees meeting predetermined criteria, alternatives are possible. For example, the mapping module 22 may include one or more routines for automatically generating one or more of the benefits cards 20 or contents thereof based on a mapping function implemented by the mapping module 22 with reference to information describing employee characteristics that is maintained in the employee data repository 18.

When an employee or prospective employee logs into the system 10, such as via the employee user interface 12, and begins to navigate the user interface 12 to view one or more cards 24, the decision guidance module 14 registers the identity of the employee. The identity information is employed by the benefits mapping selection module 22 to retrieve a set of predetermined information about the employee. The predetermined information may include criteria, such as age, marital status, home address location, number of dependents, and so on, for selecting benefits and welfare options. The mapping selection module 22 employs the criteria to determine or match the employee with one or more other employees in the employee data repository. Benefits related decisions or choices made by other employees with matching criteria may be registered via the benefits mapping selection module 22. The results of these previous choices may be uploaded to one or more of the benefits cards 20. Alternatively, or in addition, the results are employed to automatically (or manually via the administrator) select a preexisting card from the set of one or more benefits cards 20.

Note that in certain implementations, where large numbers of employees exhibit criteria that match the employee that is logged into the user interface 12, averages of previously made benefits choices may be computed. The choices made by employees with matching criteria may be averaged to determine example benefits related choices to present to a user. Alternatively, most commonly selected choices may be used to present an example set of benefits-related decisions via one or more of the cards 20. A selected card or a generated card from among the benefits cards 20 is then forwarded to the employee user interface 12 for presentation to the user via an electronic card, which may be implemented as a user interface widget.

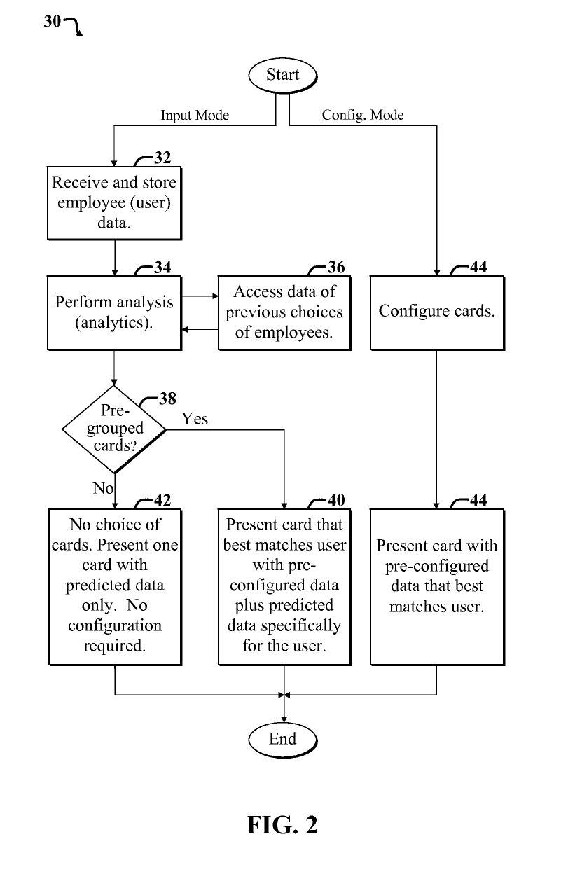

FIG. 2 is a flow diagram of a process 30 adapted for use with the system of FIG. 1. The example process 30 includes two modes. In a first mode, called an input mode, user data, e.g., pertaining to an employee or prospective employee, is retrieved in a data-retrieving step 32. Subsequently, analytics are performed on the data in an analysis step 34.

The analysis step 34 may include input pertaining to data indicative of previous choices of employees retrieved via a preexisting-data step 36. The analysis step 34 may employ the user's data obtained in the data-retrieving step 32 and previously accumulated employee data obtained from the preexisting-data step 36 to match the user with one or more choices made previously by employees with similar characteristics or criteria as the user.

Subsequently, a card-group checking step 38 is performed. The card-group checking step 38 determines whether cards have been pre-grouped, i.e., pre-configured based on criteria associated with different benefits choices. If the cards have not been pre-grouped, then a first card-presentation step 42 is performed. The first card-presentation step 42 includes presenting one card with predicted data only to the user.

If the cards have been pre-grouped, then a second card-presentation step 40 is performed. The second card-presentation step 40 includes presenting several cards to the user, where each card includes pre-configured data. The user may then choose the card, or benefits options associated with the card, that best match(es) themselves. The chosen card may include predicted benefits choices, i.e., choices that the underlying system predicts that the user will make based on all available employee data and information about various benefits plans and associated options.

Predictions as to benefits choices may be calculated in the analysis step 34. Note that exact details of algorithms for making predictions as to what employees will choose are implementation specific. Those skilled in the art with access to the present teachings may readily determine and implement appropriate algorithm details to meet the needs of a given implementation without undue experimentation.

In a second operational mode, called the configuration mode, an administrator or other authorized person, employs a user interface, such as the administrator user interface 16 of FIG. 1, to configure cards in an initial card-configuration step 44.

Resulting pre-configured cards may be presented to the user in a third card-presentation step 46, whereby a user may choose a card from among a group of cards, and where the chosen card may include pre-configured data that best matches the user. Upon selection of a card, the accompanying widget may provide additional user options, such as for making benefits-related selections, completing forms, entering additional employee data via a questionnaire, and so on.

Resulting pre-configured cards are also made available to the second card-presentation step 40. However, in the second card-presentation step 40, the pre-configured cards may be augmented with analytics information, such as predicted benefits-related choices, demographic graphs, maps, and so on.

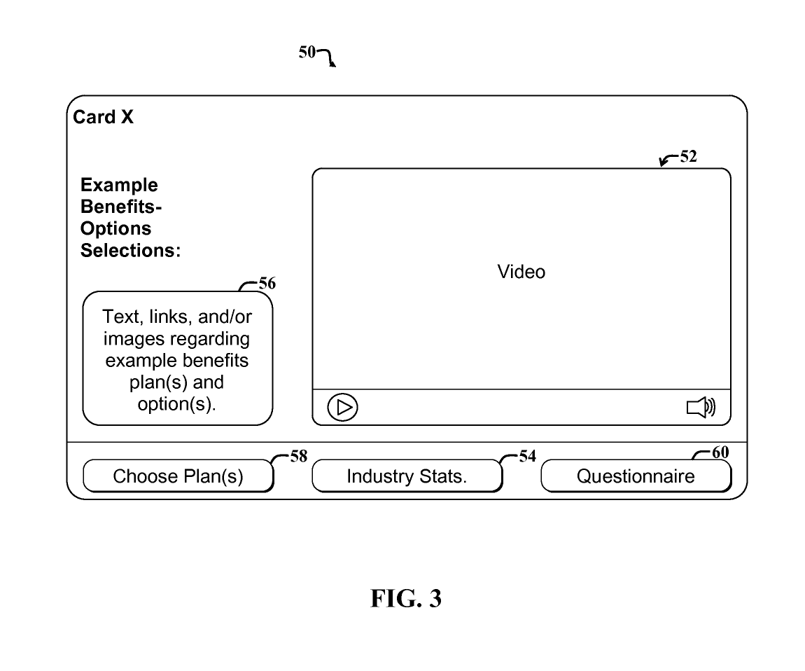

FIG. 3 is a diagram of an example card 50 to be displayed via a user interface display screen via a widget for presenting benefits-related information to a user. The card 50 includes a video user interface control 52 for viewing a video, a text field for reading text 56, a control for viewing industry-wide statistics 54, an option to choose one or more benefits plans 58, and a questionnaire option 60 to trigger display of a questionnaire to enable a user, such as an employee or prospective employee, to enter additional data, i.e., criteria. The criteria may represent information that is relevant to selection of one or more benefits plans or options.

For the purposes of the present discussion, a widget, also called a Graphical User Interface (GUI) widget, may be any dialog box, text box, window, or other element or collection of elements of a graphical user interface that is adapted to facilitate manipulating, interacting with, and/or viewing a particular collection of or type of data.

The video control 52 and text fields 56 may provide an indication as to what other persons who exhibit similar characteristics or criteria as the user have chosen in terms of benefits plans and options. In general, in the present specific embodiment, the characteristics or criteria may be categorized into one or more of the following categories: family status, gender, location, organization, generic factors, and all factors delivered for benefits eligibility.

An administrator involved in establishing the content of the card 50 may perform one or more of the following: establish the content, layout, and/or functionality of a card; choose a type of card to be presented; add video clips to a card; add documents, links to documents, and/or text; and/or add eligibility criteria that must be met by a user to warrant display of a particular card, and so on. A user, such as an employee, generally employs the card 50 to observe example benefits choices and to become informed. A user may also supply additional information to facilitate display of a card with appropriate content.

When a user selects the industry-wide statistics control 54, the underlying system may access a remote database or other data repository that maintains statistics on industry-wide choices made by users or employees with similar characteristics as the user, as discussed more fully below.

Selection of the plan-selection control 58 may trigger display of another dialog box or control within the card 50 for enabling a user to select, and/or to sign up for, a particular benefits plan or option. Exact details of additional dialog boxes or other mechanisms for enabling a user to choose a plan or option are implementation specific and may be readily determined and implemented by those skilled in the art with access to the present teachings without undue experimentation.

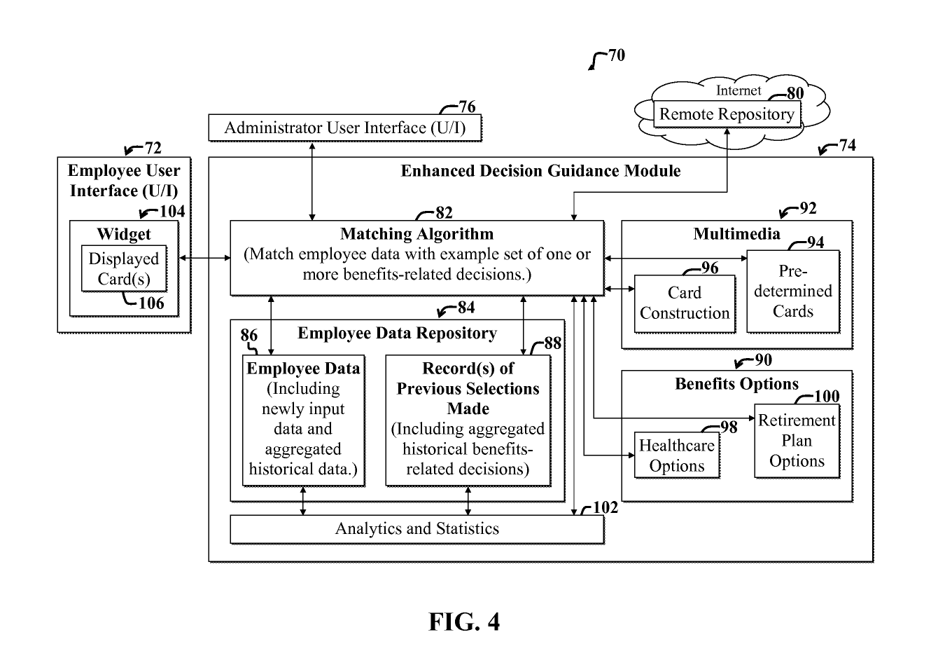

FIG. 4 is a more detailed diagram illustrating a second example embodiment of a system 70 for facilitating conveying benefits-related information a user. The system 70 includes an employee user interface 72, which includes an interactive widget 104 for selectively displaying one or more cards 106 with benefits-related information. The employee user interface 72 communicates with an enhanced decision guidance module 74, which communicates with an administrator user interface 76 and a remote Internet-based data repository 80.

The enhanced decision guidance module 74 includes an employee data repository 84, which stores not only data or criteria 86 pertaining to employees and/or prospective employees, but maintains selection records 88. The selections records 88 represent a log of previous benefits-related choices made by previous employees and/or prospective employees. The employee data repository 84 communicates with an analytics and statistics module 102, which includes one or more routines for analyzing data in the employee data repository 84 and computing statistics, such as predictions as to what benefits-related selections or choices a given user of the employee user interface 72 will make. Exact details of the algorithms employed in the analytics and statistics module 102 are implementation specific and may vary. Those skilled in the art with access to the present teachings may readily implement appropriate details of the algorithm to meet the needs of a given implementation without undue experimentation.

A matching algorithm 82 communicates with the employee data repository 84, benefits options repository 90, a multimedia repository 92, and the remote repository 80. The benefits options repository 90 stores benefits related information, including information about particular health care policies 98, retirement plans 100, and so on.

The multimedia repository 92 may store pre-configured cards 94 and may further include a card-construction module 96. The multimedia repository 92 also communicates with the administrator user interface 76.

In operation, an administrator may employ the administrator user interface 76 to configure the enhanced decision guidance module 74 to operate in various modes and to configure how the matching algorithm works 82 and to establish predetermined cards 94.

For example, in a first operational mode, an administrator has employed one or more software routines running on the administrator user interface 76 to configure the enhanced decision guidance module 74 to automatically generate one or more cards for presentation to a user based on input received from the employee via the employee user interface 72. In this case, the card-card construction module 96 employs input received via the matching algorithm 82 to automatically generate one or more cards for display via the widget 104 of the employee user interface 72, as discussed more fully below.

The matching algorithm 82 is adapted to analyze employee data pertaining to the user of the employee user interface 72 and stored in the employee data repository 84 to match the employee with data pertaining to other employees or previous employees. Benefits-related choices previously made by other employees, and stored among the selections records 88, are extracted. The analytics and statistics module 102 then performs any predetermined analysis upon the extracted selection records 88. The analysis may yield a prediction or estimate as to what the user of the employee user interface 72 may choose when making benefits-related decisions.

The matching algorithm 82 may then check the extracted selections records 88 against known benefits options 90 to ensure that previous benefits-related selections are applicable to currently available benefits options 90. This process may result in a set of one or more example benefits-related decisions that are to be presented to the user of the user interface 72 as examples of decisions made by others.

The matching algorithm 82 then references the multimedia repository 92 to either automatically generate a card containing information pertaining to the one or more example benefits-related decisions or to select a preexisting card 94, depending upon the operational mode of the system 70. The information pertaining to example benefits-related decisions or selections is then forwarded, via the matching algorithm 82, to the widget 104 of the employee user interface 72 for presentation to the user.

In the present example embodiment, the widget 104 is interactive, such that a user may employ the widget to enter additional data into the employee data repository, select or sign up for certain benefits options 90, and so on. Note however, that the widget 104 need not be interactive in certain implementations.

In addition, a user may employ the widget 104 to activate display of a questionnaire; to complete a questionnaire and provide resulting input to the enhanced decision guidance module 74, and so on. Responses to the questionnaire are stored in a repository of employee data 84. A questionnaire implemented via the widget 104 is adapted to retrieve information pertaining to criteria, wherein the criteria indicate whether an employee or prospective employee is eligible for a particular benefits plan. Examples of criteria include the number of dependents, location, age, organization, marital status, and gender of the employee or prospective employee. Questionnaire functionality may be omitted without departing from the scope of the present teachings.

Note that while various modules of the system 70 are shown separately, various modules may be combined into a single software package running on a single machine. In addition, the modules may be distributed among a network without departing from the scope of the present teachings.

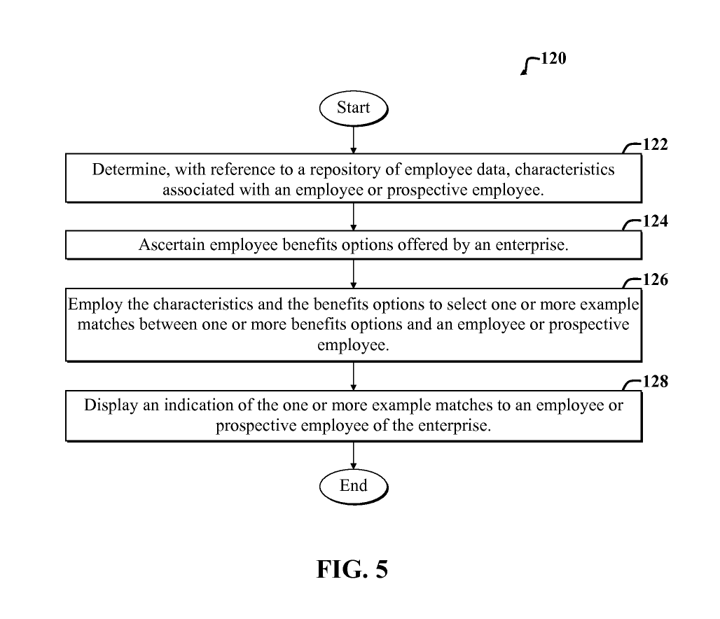

FIG. 5 is flow diagram of a first example method 120 adapted for use with the embodiments of FIGS. 1-4. The method 120 includes a first step 122, which involves determining, with reference to a repository of employee data, characteristics associated with an employee or prospective employee. The characteristics may act as criteria for determining what benefits or welfare policies a user is eligible for.

A second step 124 includes ascertaining employee benefits options offered by an enterprise. Examples of benefits options include an option to select a particular healthcare policy or option thereof; a particular retirement policy or option thereof, and so on.

A third step 126 includes employing the characteristics and the benefits options to select one or more example matches between one or more benefits options and an employee or prospective employee. The example matches may correspond to benefits options that were previously selected by other employees and/or prospective employees, wherein predetermined characteristics of the other employees and/or prospective employees match those of the employee or prospective employee.

A fourth step 128 includes displaying an indication of the one or more example matches to an employee of the enterprise.

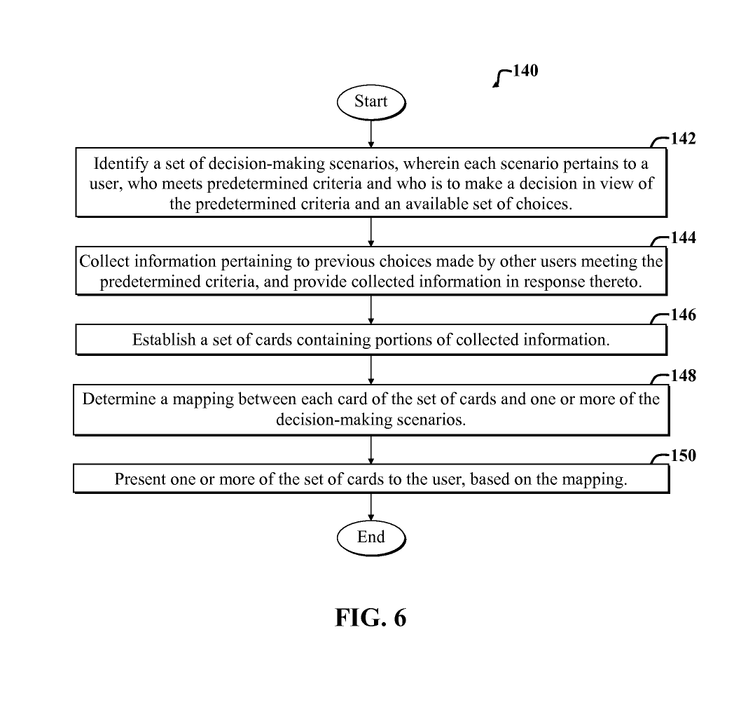

FIG. 6 is a flow diagram of a second example method 140 adapted for use with the embodiments of FIGS. 1-4. The second example method 140 includes a scenario-identification step 142, which involves identifying a set of decision-making scenarios, wherein each scenario pertains to a user, who meets predetermined criteria and who is to make a decision in view of the predetermined criteria and an available set of choices.

Subsequently, an information-collection step 144 includes collecting information pertaining to previous choices made by other users meeting the predetermined criteria, and providing collected information in response thereto.

Next, a card-determination step 146 includes establishing a set of cards containing portions of collected information.

Subsequently, a mapping-determination step 148 includes determining a mapping between each card of the set of cards and one or more of the decision-making scenarios.

Next, a card-presentation step 150 includes presenting one or more of the set of cards to the user, based on the mapping.

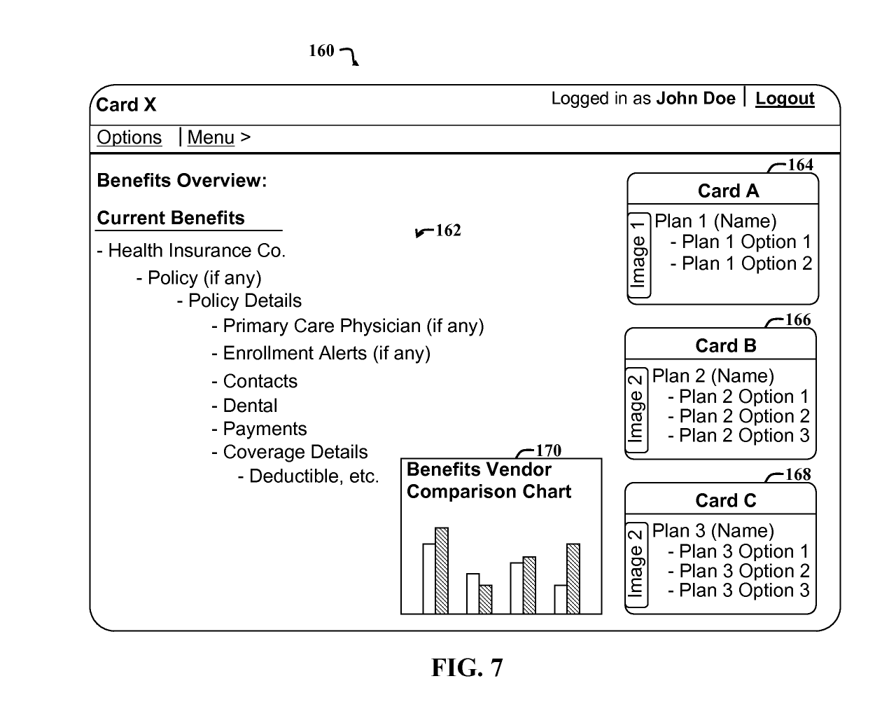

FIG. 7 is a diagram illustrating an example user interface display screen 160 showing multiple cards 164-168, which are presented to an employee or prospective employee that has logged into an employee user interface.

The example user interface display screen 160 illustrates example details 162 of any current benefits or policies that the employee is currently signed up for. In the present embodiment, the current user, e.g., John Doe, has logged into a system, such as the system 10 of FIG. 1, via a user interface, such as the employee user interface 12 of FIG. 1.

With reference to FIGS. 1 and 7, the decision guidance module 74 has determined, based on predetermined knowledge of the employee John Doe, which cards 164-168 to display via the example display screen 160. The cards, which include a card A 164, a card B 166, and a card C 168, represent benefits plans, such as health insurance policies, that previous employees matching data or criteria of John Doe have selected. The cards may include, for example, image data and details about the example plans presented in each card. The example cards 164-168 present information for so-called matching policies, i.e., benefits packages or other plans that match the user based on previously made selections by other employees or prospective employees that have similar characteristics or policy-selection criteria as John Doe.

For illustrative purposes, the example user interface display screen 160, further shows a comparison chart 170 comparing one or more policies associated with the cards 164-168 with predetermined metrics. Exact details of the comparison chart 170 or other information presented in the user interface display screen 160 are implementation specific and may be varied and/or augmented with additional information without departing from the scope of the present teachings. For clarity, various features of the chart 170, such as axis, are omitted. Those skilled in the art may readily implement software for displaying implementation specific details, such as particular axis, without undue experimentation.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for selectively conveying information, the method comprising:
determining, with reference to a repository of employee data, characteristics associated with an employee or prospective employee;
ascertaining employee benefits options offered by an enterprise;
employing the characteristics and the benefits options to select one or more example matches between one or more benefits options and an employee or prospective employee; and
displaying an indication of the one or more example matches to an employee or prospective employee of the enterprise.

2. The method of claim 1, wherein the indication includes a card displayed to a user via a user interface.

3. The method of claim 2, further including providing an administrator user interface, wherein the administrator use interface is adapted to enable an administrator to specify information specified via a card of a set of cards.

4. The method of claim 3, wherein employing includes selecting a card from among the set of cards to display to the employee or prospective employee, as the indication, based on the characteristics.

5. The method of claim 4, wherein the selected card is adapted to convey information pertaining to an example set of previously made choices by others with characteristics that match the characteristics of the employee or prospective employee.

6. The method of claim 1, wherein determining further includes providing a questionnaire to the employee or prospective employee, wherein responses to the questionnaire are stored in a repository of employee data.

7. The method of claim 6, wherein the questionnaire is adapted to retrieve information pertaining to criteria, wherein the criteria indicates whether an employee or prospective employee is eligible for a particular benefits plan.

8. The method of claim 7, wherein the criteria includes the number of dependents, location, and age of the employee or prospective employee.

9. The method of claim 1, wherein employing further includes using a mapping algorithm to automatically match data associated with the employee or prospective employee with example benefits choices.

10. The method of claim 9, wherein displaying further includes displaying a widget to the employee or prospective employee via a user interface, wherein the widget is adapted to display a card containing the indication.

11. The method of claim 10, wherein the indication includes a video displayed via the card.

12. The method of claim 10, wherein the widget includes a user option to enable the employee or prospective employee to select from among one or more benefits options.

13. The method of claim 9, wherein the repository of employee data includes data indicating a history of previous decisions made by employees or prospective employees of the enterprise.

14. The method of claim 13, wherein employing further includes determining previous decisions made by one or more employees or prospective employees that exhibit characteristics or selection criteria matching characteristics of an employee or prospective employee that is to make a decision pertaining to one or more benefits options.

15. The method of claim 14, wherein the one or more benefits options include an option to select a particular health care provider.

16. The method of claim 14, wherein the one or more benefits options include an option to select a particular retirement plan.

17. The method of claim 1, wherein employing further includes running an algorithm to generate a prediction as to what benefits options the employee or prospective employee will chose based on previous choices made by one or more employees of the enterprise.

18. The method of claim 1, wherein displaying further includes providing information pertaining to the prediction to the employee or prospective employee.

19. An apparatus comprising:
one or more processors; and
logic encoded in one or more tangible media for execution by the one or more processors and when executed operable to:
determining, with reference to a repository of employee data, characteristics associated with an employee or prospective employee;
ascertaining employee benefits options offered by an enterprise;
employing the characteristics and the benefits options to select one or more example matches between one or more benefits options and an employee or prospective employee; and
displaying an indication of the one or more example matches to an employee or prospective employee of the enterprise.

20. A processor-readable storage device including instructions executable by a digital processor, the processor-readable storage device including one or more instructions for:
determining, with reference to a repository of employee data, characteristics associated with an employee or prospective employee;
ascertaining employee benefits options offered by an enterprise;
employing the characteristics and the benefits options to select one or more example matches between one or more benefits options and an employee or prospective employee; and
displaying an indication of the one or more example matches to an employee or prospective employee of the enterprise.
